(19) United States
(12) Patent Application Publication
(10) Pub. No.: US 2014/0125272 A1
(43) Pub. Date: May 8, 2014

(54) METHOD AND APPARATUS FOR CHARGING A BATTERY IN PARALLEL WITH A DEVICE POWERED BY THE BATTERY

(71) Applicant: MOTOROLA SOLUTIONS, INC., Schaumburg, IL (US)

(72) Inventor: Frederick J. Weissinger, Duluth, GA (US)

(73) Assignee: MOTOROLA SOLUTIONS, INC., Schaumburg, IL (US)

(21) Appl. No.: 13/671,094

(22) Filed: Nov. 7, 2012

(51) Int. Cl. H02J 7/00

(52) U.S. Cl. 320/107; 320/137

(57) ABSTRACT

A method and apparatus for charging battery connected to a device and in parallel with the device includes a clamp circuit that detects changes in the charging voltage indicative of changes in the current demand by the device. In response to detected changes in load, the charger increases charging current to prevent discharge of the battery by supplying enough current to meet increases in demand by the device.

### FIELD OF THE DISCLOSURE

Embodiments relate generally to battery chargers and battery charging, and more particularly to charging a battery that is coupled in parallel to a device powered by the battery being charged.

### BACKGROUND

It is common for a portable electronic device to be powered by a rechargeable battery, and for that battery to be recharged while the battery is connected to the device. In order to charge the battery while the device is operating, a charger must provide more current than is needed by the device to operate, otherwise the battery will continue to drain, rather than recharge. In devices that have a consistent current drain, or a relatively insignificant current drain variation while operating, a charger can simply provide a constant current (until voltage limited) at the charging rate plus some additional current to account for device current drain and recharge the battery at approximately the desired rate. This approach works when the device current drain tends to be a small fraction of the charging current. If the device draws a substantial amount of current relative to the charging rate, the charger must be designed to provide the overhead current, which can require larger, more expensive components.

In devices that have a broad dynamic range of current drain, applying a constant current can complicate battery charging. High current modes of the device can divert charging current from the battery to power the device if the charger is not able to provide enough current to do both. In such situations it is common to design the device such that the battery can be isolated from the device while the device is connected to a charger so as to allow normal charging at a constant rate while powering the device. However, this can require additional complexity in the device and the charger, and also require a charger that can source both the necessary charging current and current to power the device, which requires the charger to have more capacity than is necessary to only charge the battery, meaning it requires larger and typically costlier components to meet the demand of both. Thus, it is desirable to be able to charge the battery in parallel with the device, without circuitry to isolate the battery from the device, and without requiring the charger to have to source enough current to both charge the battery and power the device.

Accordingly, there is a need for a method and apparatus for charging a battery in parallel with a device powered by the battery.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of battery charger and system in accordance with some embodiments;

FIG. 2 is a schematic of a load detector in accordance with some embodiments;

FIG. 3 is a schematic of a load detector in accordance with some embodiments;

FIG. 4 is a schematic of a load detector in accordance with some embodiments;

FIG. 5 is a comparison graph of various currents and voltages while charging a battery in accordance with some embodiments;

FIG. 6 is a comparison graph of various currents and voltages while charging a battery in accordance with some embodiments; and

FIG. 7 is a flow chart of a method of charging a battery in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments include a battery charger having a charging interface configured to connect the battery charger to a device having a battery. The battery is generally connected in parallel with the device circuitry from the perspective of the charging interface looking into the device. The battery charger can further include a charge regulator that is operable to provide a regulated charge current and charge voltage to the charger interface. The battery charger can also have a load detector that is operable to detect changes in load at the charging interface based on deviations in the charging voltage, and produce a load signal indicative of changes in the charging voltage. The battery charger can further include a load regulator that is responsive to the load signal and which is operable to control the charge regulator to, during periods of increased load as indicated by the load signal, maintain the charging voltage at a substantially constant level by increasing the charge current.

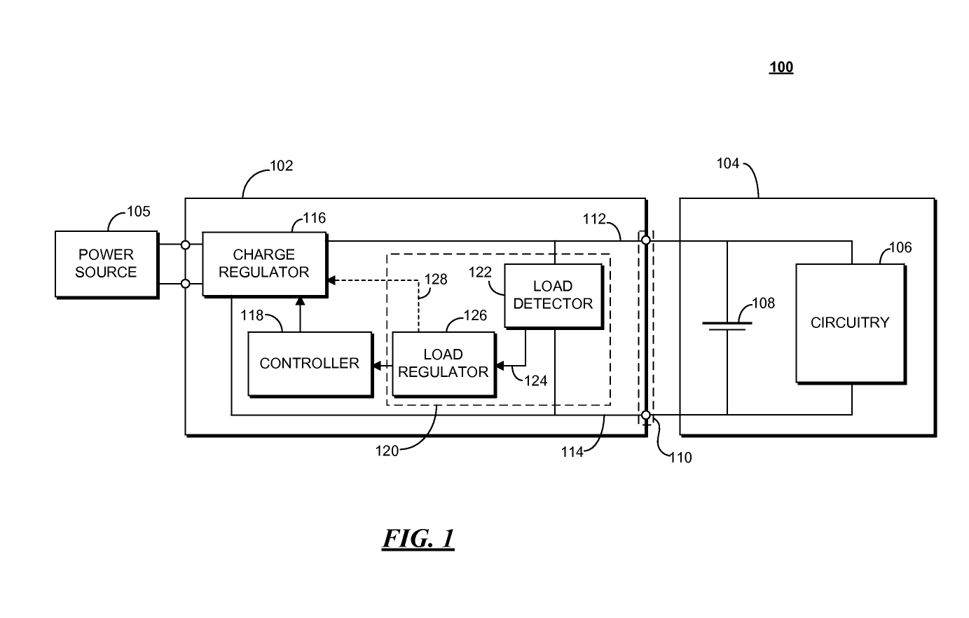

FIG. 1 is a block diagram of battery charger 102 and system 100 in accordance with some embodiments. Generally, the battery charger 102 supplies a charging current and charging voltage to a device 104 from a power source 105. The device 104 has internal circuitry 106 that is powered by a battery 108 coupled in parallel with the circuitry 106 from the perspective of a charging interface 110. The device 104 can be powered on and operating while the battery 108 is being charged, and the circuitry 106 can operate in several different modes, each mode having a different current demand. For example, the device 104 can be a portable two-way radio device having, generally, three modes of operation; standby, receive, and transmit. In standby mode, where the radio device is neither transmitting nor receiving a modulated audio signal, the radio device uses relatively little current. In a typical two-way radio device, the standby current used by the device will be a small fraction of the typical charging current used to charge a connected battery. Generally, a two-way radio device will operate in standby most of the time it is operating, and while in standby mode it is receiving signals to determine if there is a signal of interest that requires further processing, such as activating an audio amplifier to play received audio information. Even though the two-way radio device is receiving signals in standby mode, the device is said to be in receive mode when it is receiving a signal of interest that requires further processing, such as playing the received signal over a speaker of the device. Accordingly, in receive mode, the device uses more current than while in the standby mode in order to, for example, drive an audio power amplifier and speaker. In receive mode the current required by the device can vary based on, for example, a volume setting of the device (e.g. a higher volume setting requires more current). In transmit mode, where the two-way radio is transmitting a wireless radio signal, the device will typically use the most current, often at levels that exceed the even the charging current level used to charge the battery 108. As used here, the term “charging current” refers to the current output by the battery charger 102. The charging current, as it leaves the battery charger 102, can pass through the battery 108, circuitry 106, or a combination of the battery 108 and circuitry 106, or in some cases only circuitry 106.

The battery 108 provides power for the circuitry 106 during operation of the device 104. The battery 108 has a battery voltage, which can change. Generally, as a battery 108 discharges, its battery voltage decreases, and when the battery 108 is charged, its voltage increases. Thus, when the circuitry 106 changes modes (and therefore current demand), the battery voltage will change slightly, but measurably. The changes from standby to receive or transmit, and vice versa, are fairly abrupt, and thus produce likewise abrupt changes in battery voltage.

When the device 104 is coupled to the charger 102, such as via the charging interface 110, the charger 102 is able to supply charging current and charging voltage to the charging interface 110, such as by a positive line 112 and a return or negative line 114. A charge regulator 116 provides a regulated current to the charging interface 110. The charger regulator can be, for example, a current regulated DC to DC or AC to DC power converter. The term “charging voltage” refers the voltage output by the battery charger at the charging interface 110, between lines 112, 114. The charge regulator 116 can sense charging voltage (e.g. between lines 112, 114) and current output for feedback control in any known manner. The charge regulator 116 can be further controlled by a controller 118. The controller 118 can control the charge regulator to implement a particular charge regime for charging battery 108, or any other battery. A charge regime specifies charging parameters, such as charging current rate, voltage limit, end of charge conditions, and so on. The controller 118 can be implemented by, for example, a microcontroller or microprocessor executing computing instruction code in accordance with the teachings provided herein.

While charging the battery 108 via charging interface 110, the charge regulator 116 typically applies a constant charging current, at least initially. Given a constant current into the charging interface 110, and therefore into device 104, the charging voltage between lines 112, 114 will be dictated primarily by the battery 108. However, when the device circuitry 106 changes state or mode, or otherwise changes its electric current demand, the charging voltage will fluctuate accordingly, without compensation. As device circuitry 106 changes states and current demand, the load at the charging interface 110 will change. In some cases the current demand of the device circuitry 106 can exceed the charging current supplied by the charge regulator 116, which would result in the battery 108 discharging to make up the difference and as a result, the charging voltage would drop. In some embodiments, the charge regulator may not be capable to provide enough current to continue charging the battery 108 at the desired rate and provide enough additional current to meet the load demand of the circuit 106. However, the charger 102, operating in accordance with some embodiments, is able to provide enough current to meet the demand of the circuitry, at least for short periods of time, such as during a transmit event of a two-way radio.

The charger 102 includes a voltage clamp circuit 120 that samples the charging voltage and maintains a present sample of the charging voltage. When the load at the charging interface 110 increases (e.g. demands more current), the charging voltage, which would tend to drop in response to the increased current demand, is controlled by increasing the current until the charging voltage is either substantially equal to, or at an offset lower than the sampled voltage. In some embodiments, the voltage sample can be stored using various sample and hold or sample and store techniques. A load detector 122 can detect changes in the load at the charging interface 110 by comparing the present charging voltage (between lines 112, 114) with the sampled charging voltage, and provide a load signal 124 to a load regulator 126 which provides a compensation signal 128 to the controller or the charger regulator. The compensation signal 128 causes the charge regulator 116 to adjust its current output. If the load at the charging interface 110 increases, the effect of the clamp circuit 120 is to cause the charge regulator 116 to adjust its current output to cause the charging voltage to stay substantially constant and equal to, or at an offset lower than the sampled voltage. As a result, if the charging current is raised to a level that causes the charging voltage to remain substantially equal to the sampled voltage level, then the battery 108 will still receive charge current as before and the extra current will go to the circuitry 106. This will allow the battery 108 to continue to charge while supplying low or medium current demands from circuitry 106. Additionally, if the charging current is raised to a level that causes the charging voltage to remain at an offset lower than the sampled voltage level, then the battery 108 will receive little or no current, and the circuitry 106 will receive the majority, if not all the charging current.

If, in response to an abrupt increase in load at the charging interface 110, the charging current is controlled to cause the charging voltage to remain substantially at some offset below the sampled voltage level, the circuitry 106 will receive charge current and battery 108 will receives the difference between the charging current and the current through the circuitry 106, or the charging current will be distributed between the battery 108 and the circuitry 106 while the charging current does not exceed a maximum charging current output level. This lower offset voltage can be predetermined or calculated or stored in a table within a memory device coupled to the controller 118. In some embodiments the offset can be determined empirically by one or more charging tests of the device 104 which can be performed once, such as upon connecting the device 104 to the charger 102, or periodically, such as throughout the life of device 104, so as to account for impedance changes in battery 108 as aging occurs. For example, the difference between the open circuit voltage (e.g. no charging current) and the charging voltage when applying a known charging current can be determined and used as, or to determine a preselected offset. When a high load is detected, the charging voltage can be controlled, by adjusting the charge current, to a level substantially equal to the stored charging voltage sample minus the preselected offset. Accordingly, the battery 108 will not be substantially discharged during a high load period.

Similarly, when the load at the charging interface 110 is decreased, the charging current will then flow into the battery 108, which would cause the charging voltage at the charging interface 110 to rise in response. The clamp circuit 120 can detect the tendency of the charging voltage to rise, via the load detector 122, by comparing the present charging voltage with the sampled voltage, and control the charge regulator 116 to decrease current until the charging voltage substantially equals the sampled voltage, or until the charging current is dropped to a nominal charging current rate for the battery 108. Accordingly, the clamp circuit 120 clamps the charging voltage during periods of increased load by adjusting the charging current supplied by the charge regulator 116 to the charger interface 110 to meet the load demand such that the battery 108 does not significantly discharge during the increased load period. The increased load period can be, for example, the time while a two-way radio (as device 104) is transmitting.

By not having to continue charging the battery during periods of high load demand, the charger 102 can be designed with smaller, less expensive components. In some embodiments the charger 102 can be a holster charger that can be worn by a user. The charging interface 110 can be disposed in a holster connected to the holster charger, and in which the device 104 can be carried by the user. The power source 105 can itself be a battery that is carried in a holster, along with a holster charger.

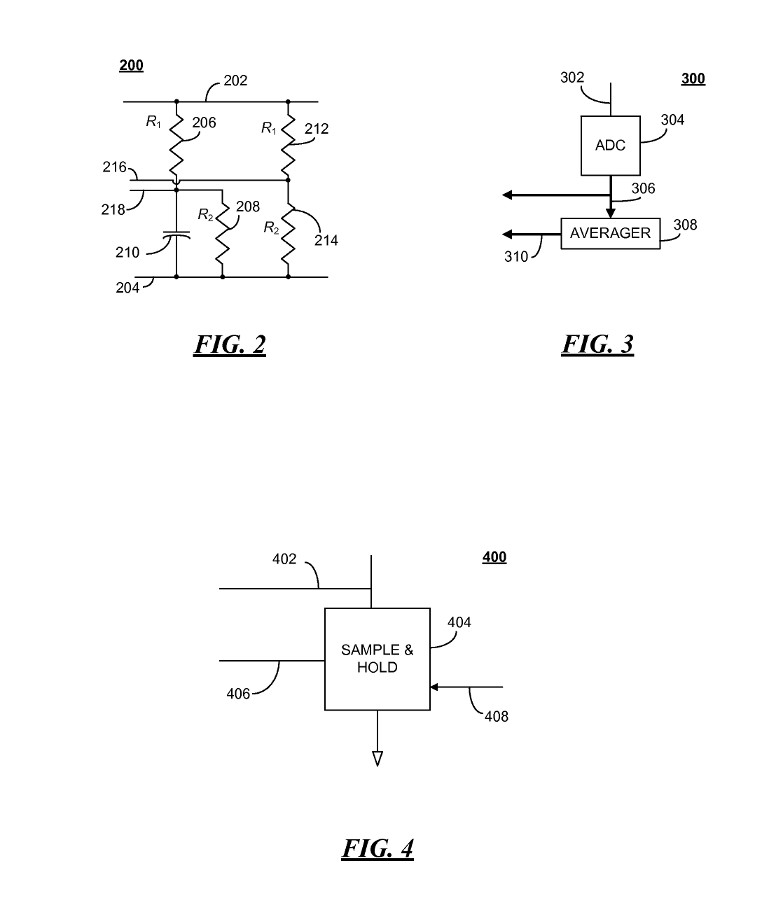

FIGS. 2-4 are schematics of different possible embodiments of load detectors 200, 300, and 400, respectively, in accordance with some embodiments. In load detector 200 is an analog resistor-capacitor (RC) integrator network. The RC network can be connected between a positive charging voltage line 202 and a return or negative charging line 204. Lines 202, 204 can be similar to line 112, 114 of FIG. 1. The network uses a pair of resistor dividers 206, 208 and 212, 214. The ratio of the resistance values of resistor 206 to 208 can be the same as the ratio of resistor 212 to resistor 214. Accordingly, under steady state conditions where the voltage between lines 202, 204 is stable, the voltage at the center of the two dividers, on lines 216, 218, will be substantially equal. However, when the voltage between lines 202, 204 changes sufficiently abruptly, because of capacitor 210 coupled in parallel with resistor 208, the voltage on line 218 will lag behind the voltage on line 216. Thus, a voltage difference between lines 216, 218 can be used to infer changes between lines 202, 204 that occur faster than the RC time constant of the network resulting from resistors 206, 208, and capacitor 210. The difference between lines 216, 218 can be used as the load signal or used to derive the load signal. The time constant of the RC network can be selected to have a time constant that maintains the voltage on line 218 substantially equal to the voltage on line 216 as the battery voltage changes while being charged, but which allows a significant difference between the voltages on lines 216, 218 when the charging voltage changes sufficiently abruptly, such as when the load changes abruptly.

Load detector 300 includes an analog to digital converter (ADC) 304 that converts the charging voltage, such as the voltage between line 112, 114 of FIG. 1 to a digital value that is proportional to the sampled voltage. The output 306 of the ADC 304 can represent a present value of the charging voltage. An averager or integrator 308 can be used to average the present value of the charging voltage with one or more previous samples to produce a time-based recent average value 310 of the charging voltage. The difference between lines 306, 310 can be used as the load signal or used to derive the load signal. If the difference between them exceeds some preselected threshold, then the charging voltage has changed abruptly. The averaged value 310 can be stored and used to adjust the charging current until the charging voltage, as indicated by present charging voltage sample 310, is substantially equal to the averaged value. The averaging performed by averager 308 can be designed to have a particular time constant that maintains the average 310 substantially equal to the present charging voltage value 306 as the battery voltage changes while being charged.

Load detector 400 samples the charging voltage 402 (or a voltage proportional to the charging voltage), with a sample and hold circuit 404. The sample and hold circuit 404 periodically stores the value of charging voltage 402, and can provide the stored value on line 406. The sample and hold circuit can sample at a rate dictated by a control signal or input 408. Furthermore, the sample and hold circuit can be implemented as either an analog circuit or a digital circuit that includes an ADC. The sampling rate of the sample and hold circuit 404, can be set in the same manner as selecting the time constant of detectors 200, 300, where normal changes in battery voltage do not result in a substantial difference between the sampled voltage 406 and the present charging voltage 402, but changes in load, which do cause abrupt changes in charging voltage, do result in a substantial difference between the sampled voltage 406 and the present charging voltage 402.

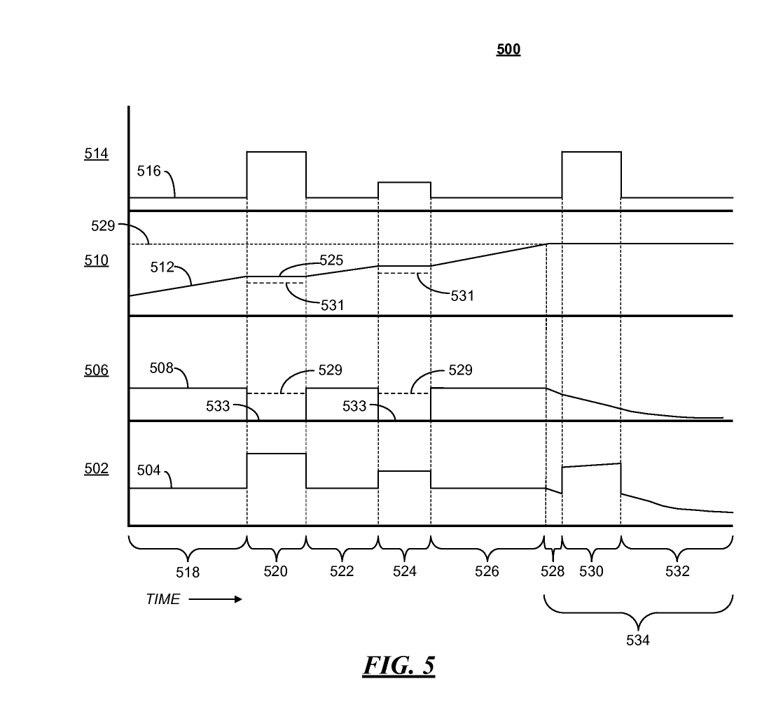

FIG. 5 is a series of comparison graphs of various currents and voltages while charging a battery in accordance with some embodiments. The horizontal axis represent time, increasing from left to right, while charging a battery that is connected in parallel to a load such as a device that operates in one of several modes, where each mode has a different current demand or range of current demand. Graph 502 graphs charging current 504 provided by a charger to a charging interface (which via the charger is coupled to the device/battery), graph 506 graphs the battery current 508 through the battery in the charging direction, graph 510 graphs the charging voltage 512 at the charging interface (and across the battery), and graph 514 graphs the device current 516 through the device circuitry. The time axis is segmented into time periods 518-534. In time periods 518, 522, 526 the charging current 504 is at a selected charging rate, the battery current 508 is equal to the difference of the charging current 504 and the device current 516, and the charging voltage 512 is increasing in response to the battery current 508. The device current can be, for example, a standby or idle current level of the device.

During time periods 520, 524 the device current 516 abruptly increases substantially relative the standby or idle current of time periods 518, 522. As a result, the charger, upon detecting the change in load, increases the charging current 504 increases to meet the demand. In time period 520 the device current is higher than in time period 524, and, accordingly, the charging current 504 is greater in time period 520 than in time period 524. In time period 520 the device can be, for example, a two-way radio that is transmitting, and in time period 524 the device can be a two-way radio in receive mode (e.g. playing audio). During time periods 520, 524, the charging voltage 512 is held substantially constant, and in some embodiments can be at the level 525 of the sampled voltage used to detect the load. When the charging voltage 512 is held substantially at the sampled voltage 525, the battery current stays substantially same or slightly less, as indicated by level 529 that it was prior to change in device current 516. In some embodiments, the charging voltage is lowered to an offset below the sampled voltage, as indicated by level 531. The offset can be, for example, equal to the difference between the voltage produced by the battery during a full charge current and the open circuit (no charge current) battery voltage. Accordingly, when the charging voltage is dropped below the sampled voltage (e.g. level 531) the battery current 508 can drop substantially to zero 533. In time periods 522, 526, when the load of time periods 520, 524 changes back to what it was, for example, in time period 518, the battery current 508 resumes at substantially its initial level (in time period 518), and the battery voltage 512 resumes increasing.

At the end of time period 526 the charging voltage 512 reaches a voltage limit 529. For example, the battery being charged can be a lithium ion battery. A typical lithium ion battery charge regime comprises applying a constant current until the battery voltage reaches a voltage limit (e.g. 4.2 volts per cell), and then the voltage is maintained as the charging current decreases as the battery continues to charge during a constant voltage period 534. Accordingly, during time period 528 the charging current 504 begins to decrease as the charging voltage 512 is held at the voltage limit 529. During time period 530, the device current 516 again abruptly increases, creating a load at the charging interface. The charging current 504 is then increased while the charging voltage 512 is held constant at the voltage limit 529, and the battery current 508 declines as battery 108 nears end of charging. At the end of time period 530, the device current drops down again to the standby level. Accordingly, by holding the charging voltage still constant at the voltage limit 529, the battery current 508 continues its normal drop as the battery is nearing end of charging. After time period 530, in time period 532, the device current 516 is at the standby level, the charging voltage 512 remains at the voltage limit 529, the battery current 508 continues to decrease as the battery continues to charge. The charging current 504 likewise continues to drop and the battery current 506 drops.

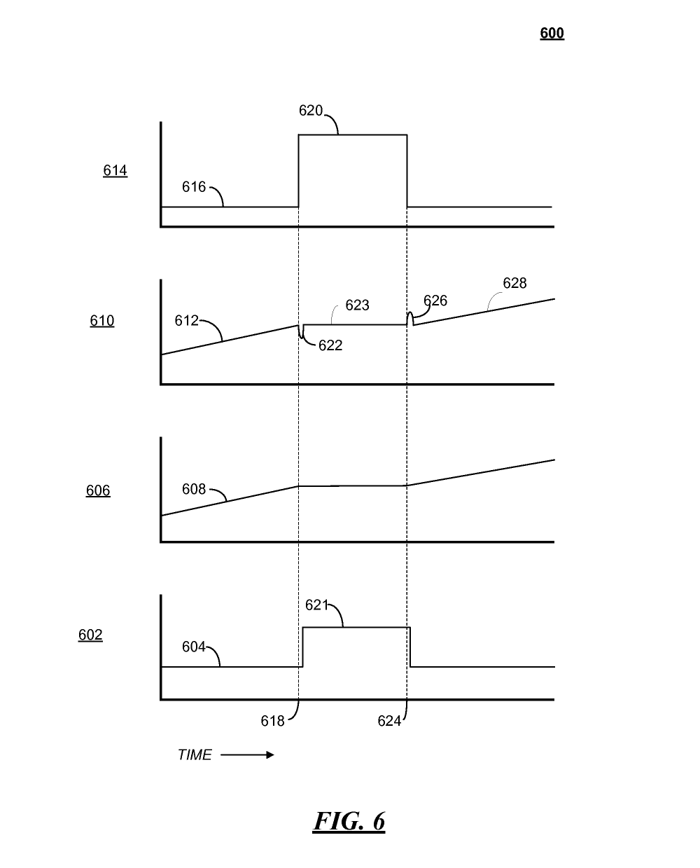

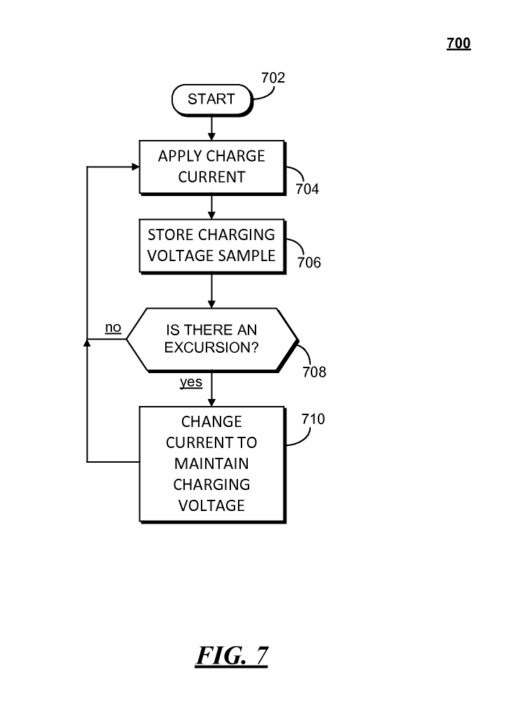

FIG. 6 is a comparison graph 600 of various currents and voltages while charging a battery and experiencing a high load event in accordance with some embodiments. Graph 602 shows a graph of charge current 604, graph 606 is a graph of stored charging voltage sample 608, graph 610 is a graph of charging voltage 612, and graph 614 is a graph of device current 616. Prior to time 618 the charging current 604 is equal to the current through the battery and the device current 616. The charging voltage 612 increases as the battery is charged, and therefore the stored charging voltage sample 608 increases accordingly. At time 618 the device current abruptly increase to a high level 620. As a result, current through the battery will decrease, causing a negative excursion 622 in the charging voltage 612. The negative excursion 622 is detected by the charger by comparing the charging voltage to the stored charging voltage sample 608. In response, the charger increases the charging current 604 to level 621 slightly after time 618, which causes the charging voltage 612 to rise to level 623, which can be a level substantially equal to or at an offset lower than the value of the stored charging voltage sample 608 or to a level within a range of stored charging voltage sample 608 sufficient to prevent any substantial discharge of the battery due to the increased load. At time 624, the device current 616 drops back down to substantially its initial level. Since the charging current 604 is still at level 621, the charging voltage will experience a positive excursion 626. The positive excursion 626 can be detected by comparing the charging voltage 612 with the stored charging voltage sample 608. In some embodiments, the charging voltage 612 can be held substantially constant after the negative excursion 622 until the occurrence of a positive excursion 626. Slightly after time 624 the charging current 604 is reduced to bring the charging voltage 612 down to level 623, and then charging resumes at the initial charging current, and the charging voltage continues rising 628 from level 623. Thus, voltage fluctuations or excursions that differ from the stored charging voltage sample 608 can be used to regulate charging current 604 so as to avoid discharging the battery during periods of high load (e.g. high device current 616). Once the battery reaches an end of charge condition, the battery can be maintained in a charged state by continuing to sample the charging voltage while a standby or trickle current is applied, and changing charging current with load as indicted by changes in charging voltage.

FIG. 7 is a flow chart of a method 700 of charging a battery in accordance with some embodiments. The method can be comprised of several processes, each represented in the abstract as a box in the flow chart diagram. The method 700 can be performed, for example, by a battery charger and system such as that shown in FIG. 1. At the start 702, the battery charger is connected to the battery/device load. The battery is connected to the device such that, from the charging interface, the battery and the device circuitry are connected in parallel. The device may be on or off in some embodiments. Upon detecting the connection to the battery/device, the battery charger commences charging by applying a charging current in process 704. Upon application of the charging current, the charging voltage can then be sampled, and stored, as in process 706. The sampling can be done digitally or using analog techniques, and it can be produced by an averaging process or by simply storing the voltage value at intervals. While charging, the charger compares the present charging voltage with the stored charging voltage sample. Changes in the present charging voltage can, in some embodiments, result in excursions from the stored charging voltage sample sufficient to indicate a change in load that requires a change in the charging current. In process 708 changes in the charging voltage relative to the stored charging voltage sample can be used to adjust the charging current in process 710 to maintain the charging voltage substantially equal to or at a lower offset to the stored charging voltage sample. The time constant of the stored charging sample is such that voltage changes due to charging are not sufficient to result in a change in charging current. Likewise, changes in the device operation from an “off” state to an “on” state, where only a relatively small standby current is drawn by the device circuitry, can be small enough to not significantly change the charging current in some embodiments.

The embodiments provide the benefit of charging a battery with a battery charger that does not need to isolate the battery from the device, and doesn't need to source enough current to maintain a constant charge current through the battery and supply any additional current demanded by the device while charging. Accordingly, the charger circuitry does not need to be designed to provide both the high current of a fast charging rate and the high demand that the device may occasionally require. Thus, the charger circuitry can be both lighter and smaller, which is beneficial for portable charging applications, such as, for example, a holster charger that can be worn on a user and used to charge the battery of a device while the user is deployed on a task or assignment.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A battery charger, comprising:
a charging interface operably coupling the charger to a device having a battery;
a charge regulator that provides a regulated charge current and charge voltage to the charger interface;
a load detector that detects changes in load at the charging interface based on deviations in the charging voltage and produce a load signal; and
a load regulator responsive to the load signal that controls the charge regulator to maintain the charging voltage at a substantially constant level by increasing the charge current during periods of increased load as indicated by the load signal.

2. The battery charger of claim 1, wherein the load detector comprises a voltage sampler that stores a recent sample voltage level of the charging voltage.

3. The battery charger of claim 2, wherein the load detector compares the charging voltage with the recent sample voltage level to produce the load signal.

4. The battery charger of claim 2, wherein the voltage sampler is a digital sampler that periodically samples and stores the charging voltage value as the recent voltage level.

5. The battery charger of claim 2, wherein the voltage sampler is an integrator circuit to sample the charging voltage and having a time constant selected such that the sampled voltage substantially tracks the charging voltage as it changes while charging a battery but produces a difference between the sampled voltage and charging voltage in response to abrupt changes in load at the charging interface.

6. The battery charger of claim 1, further comprising a battery for supplying power to the charge regulator.

7. The battery charger of claim 6, wherein the battery charger is a holster charger.

8. The battery charger of claim 7, wherein the charging interface of the holster charger is a two-way radio charging interface.

9. The battery charger of claim 1, wherein the load detector samples the charging voltage as a stored charging voltage sample, load signal controls the charge regulator to maintain the charging voltage at a substantially constant level at an offset below the stored charging voltage sample in response to the charging.

10. A method of charging a battery at a charging interface, comprising:
providing a regulated charging current to the charging interface;
maintaining a current sample a charging voltage at the charging interface, the charging voltage resulting from the charging current;
detecting a change in a load at the charging interface by comparing the sample of the charging voltage to the charging voltage; and
adjusting the charging current to maintain the charging voltage at a substantially constant level during a period where the load at the charging interface is increased.

11. The method of claim 10, wherein providing the regulated charging current to the charging interface comprises providing the regulated charging current to the charging interface from a battery.

12. The method of claim 10, wherein maintaining the current sample of the charging voltage comprises integrating the charging voltage in a resistor-capacitor network.

13. The method of claim 10, wherein maintaining the current sample of the charging voltage comprises periodically digitizing the sample of the charging voltage to produce a digital sample and storing the digital sample for at least one sampling period.

14. The method of claim 10, wherein providing the regulated charging current to the charging interface is performed while the charging voltage is at a voltage limit for a battery being charged in a constant voltage mode, the method comprises decreasing the regulated charging current as the battery continues to charge.

15. The method of claim 10, wherein providing the regulated charging current to the charging interface comprises providing the regulated charging current to a battery disposed in a device having at least two different current demand states.

16. The method of claim 10, wherein adjusting the charging current comprises:
detecting a negative transition of the charging voltage relative to the sampled voltage;
responsive to detecting the negative transition, increasing the charging current until the charging voltage substantially equals or at a lower offset than the sampled voltage;
subsequent to increasing the charging current, detecting a positive transition of the charging voltage relative to the sampled voltage; and
responsive to detecting the positive transition, decreasing the charging current until the charging voltage substantially equals the sampled voltage.

17. The method of claim 16, further comprising, responsive to detecting the negative transition and prior to increasing the charging current, determining a first charging current level, and wherein decreasing the charging current comprises decreasing the charging current to the first charging current level.

18. A battery charging system, comprising:
a charge regulator that provides a charging current and a charging voltage to a charging interface;
a controller that is operably coupled to the charge regulator and that sets a base level of the charging current; and
a clamp circuit that maintains an ongoing stored charging voltage sample and that adjusts the charging current provided by the charge regulator to the charging interface responsive to changes in a load at the charging interface indicated by the charging voltage relative to the stored charging voltage sample by increasing the charging current to maintain the charging voltage substantially equal to the stored charging voltage sample during high load periods at the charging interface.

19. The battery charging system of claim 18, wherein the clamp circuit maintains the stored charging voltage sample by periodically sampling and storing the charging voltage.

20. The battery charging system of claim 18, wherein the clamp circuit maintains the stored charging voltage sample as an average of recent charging voltage.
